(19) United States
(12) Patent Application Publication
(10) Pub. No.: US 2011/0274385 A1
(43) Pub. Date: Nov. 10, 2011

(54) AXIAL ROLLER BEARING CAGE WITH INCREASED CAPACITIES

(75) Inventor: Eric S. NELSON, CHARLOTTE, NC (US)

(73) Assignee: SCHAEFFLER TECHNOLOGIES GMBH & CO. KG

(21) Appl. No.: 13/101,228

(22) Filed: May 5, 2011

Related U.S. Application Data
(60) Provisional application No. 61/331,595, filed on May 5, 2010.

(51) Int. Cl. F16C 33/46; F16C 19/30

(52) U.S. Cl. 384/623

(57) ABSTRACT

The axial roller bearing cage has an inner ring, an outer ring, and a plurality of alternating cage bars and roller pockets, which are formed between the inner ring and the outer ring. The roller pockets of the axial roller bearing cage extend along the entire length of the cage bars, accommodating rollers of maximum length, which also enables a compact cage design for a given roller length. The cage enhances the friction characteristics between the ends of the rollers and the cage bars. The ends of the rollers are supported on a centerline, which reduces frictional torque by reducing the length of the frictional moment arm on each roller, allowing for a symmetric loading. The ends of the rollers are also supported by the inboard smooth surface of the formed flanges of the connecting elements, which increases oil film development and allows the bearing to operate at higher speeds.

This application claims the priority of U.S. 61/331,595 filed May 5, 2010, which is incorporated by reference herein.

### FIELD OF INVENTION The present invention relates to axial roller bearing cages and more particularly to a “sigma style” axial roller bearing cage.

### BACKGROUND OF THE INVENTION

Axial roller bearing cages, including “sigma style” axial bearing cages, are typically used in axial roller bearings in industrial equipment and automobile transmissions. “Sigma style” axial bearing cages are referred to as such because the cage profile resembles the capital Greek letter sigma. Currently, a design guide is used to calculate the maximum pierced roller pocket length and the longest corresponding roller for axial roller bearings. The roller pocket is pierced in the cage by a punch after forming, which limits the pocket length to the length of the punch. Additionally, the ends of the rollers are currently supported in the cage by a sheared edge support surface, which is equivalent to the thickness of the cage stock. The sheared edge supports only a fraction of the roller end surface and the support surface is offset from the roller axis, imparting asymmetric loading on the roller during operation. Moreover, the current sheared edge accommodates only a small oil film area on the end of the roller, which is a factor in limiting the bearing's maximum operating speed.

### SUMMARY OF THE INVENTION

The present invention is directed to an axial roller bearing cage with an increased roller pocket length which allows longer rollers to fit in an existing cage envelope. Lengthening the roller pocket also converts the roller end support surface from a sheared edge to a smooth surface, The larger, smoother surface improves lubrication conditions at the ends of the rollers and also aids in reducing friction, which can increase the bearing's high speed capacity.

As a result of the present invention, the ends of the rollers are supported on a centerline of the roller, which reduces frictional torque by reducing the length of the frictional moment arm on each roller and the loads on the rollers are thus symmetric. Additionally, the ends of the rollers of the improved axial roller bearing cage are supported by the smooth surface of the formed flange. The larger support surface improves oil film development and could enable higher operating speeds. Finally, the roller pockets of the cage extend to the flanges, accommodating longer rollers. For a given envelope, the bearing static and dynamic capacities consequently increase. The longer pocket conversely enables a more compact cage design for a given roller length.

Broadly, the present invention can be defined as an axial roller bearing cage, which includes an inner ring that has only a single inboard directed surface, an outer ring that has only a single inboard directed surface, and a plurality of cage bars and roller pockets formed between the inner ring and the outer ring. The roller pockets are defined by four sides. The single inboard directed surface of the outer ring forms a first side of the roller pocket. The single inboard directed surface of the inner ring forms a second side of the roller pocket, opposite the first side. Two opposing cage bars form a third side and a fourth side of the roller pocket.

In an additional embodiment, rollers sit in the roller pockets. In another embodiment, the rollers have ends and the ends are each supported on a centerline of each of the rollers.

In a further embodiment, the inner ring and the outer ring are respectively formed by a first flange and a second flange, the first flange and the second flange each having an outboard portion and an inboard portion forming a doubling.

In yet a further embodiment, the first flange, the second flange and the cage bars, in combination, for a sigma shape.

In a further embodiment, between the first flange and the second flange, each cage bar has a first segment, a second segment, a third segment, a fourth segment and a fifth segment forming the sigma shape in conjunction with the first flange and the second flange.

In an even further embodiment, the first segment is fixed perpendicular to the inboard portion of the first flange, the second segment is fixed between the first segment and the third segment in an angular manner, the third segment is fixed between the second segment and the fourth segment which is angular in an opposite direction from the second segment, the fourth segment is fixed to the third segment and the fifth segment, the fifth segment is fixed to the fourth segment and perpendicular to the inboard portion of the second flange.

In another embodiment, the roller pockets extend an entire length of the connecting elements, to the inboard portion of the first flange and the inboard portion of the second flange.

In yet another embodiment, the ends are supported by a smooth surface provided by the inboard portion of the first flange and the inboard portion of the second flange.

In a further embodiment, the inboard portion of the first flange and the inboard portion of the second flange have an end surface that extends from an edge of the roller pocket parallel to a centerline of the roller and perpendicular to the ends of the rollers.

In yet further embodiment, loading on the rollers is substantially symmetrical.

In an alternative embodiment, the inner ring and the outer ring are respectively formed by a single layer first flange and a single layer second flange.

In another embodiment, the inner ring is formed from a first flange which has an outboard portion and an inboard portion and the outer ring is formed from a second flange which has a single layer portion.

In yet another embodiment, the inner ring is formed from a first flange which has a single layer portion and the outer ring is formed from a second flange which has an outboard portion and an inboard portion.

### BRIEF DESCRIPTION OF THE DRAWINGS

The present invention will be further understood and appreciated by reading the following description in conjunction with the accompanying drawings, in which:

FIG. 1 is a side view illustrating an existing axial roller bearing cage;

FIG. 2 is a top view illustrating the existing axial roller bearing cage;

FIG. 3 is a cross-section view illustrating the existing axial roller bearing cage roller pocket;

FIG. 4 is a cross-section view illustrating an alternative existing axial roller bearing cage roller pocket;

FIG. 5 is a side view illustrating an axial roller bearing with a cage pursuant to the present invention;

FIG. 6 is a top view illustrating the axial roller hearing cage;

FIG. 7 is a cross-sectional view illustrating the axial roller bearing cage roller pocket;

FIG. 8 is a cross-sectional view illustrating an alternative axial roller bearing cage roller pocket;

FIG. 9 is a cross-sectional view illustrating the existing axial roller bearing cage to accommodate rollers;

FIG. 10 is a cross-sectional view illustrating the inventive axial roller bearing cage roller pocket that accommodates longer rollers; and

FIG. 11 is an isometric view of a pocket configuration for the cage.

### DETAILED DESCRIPTION OF THE INVENTION

Referring now to the drawings, in which like reference numerals refer to like reference parts throughout, FIG. 1 shows a side view of a known “sigma style” axial roller bearing cage 10.

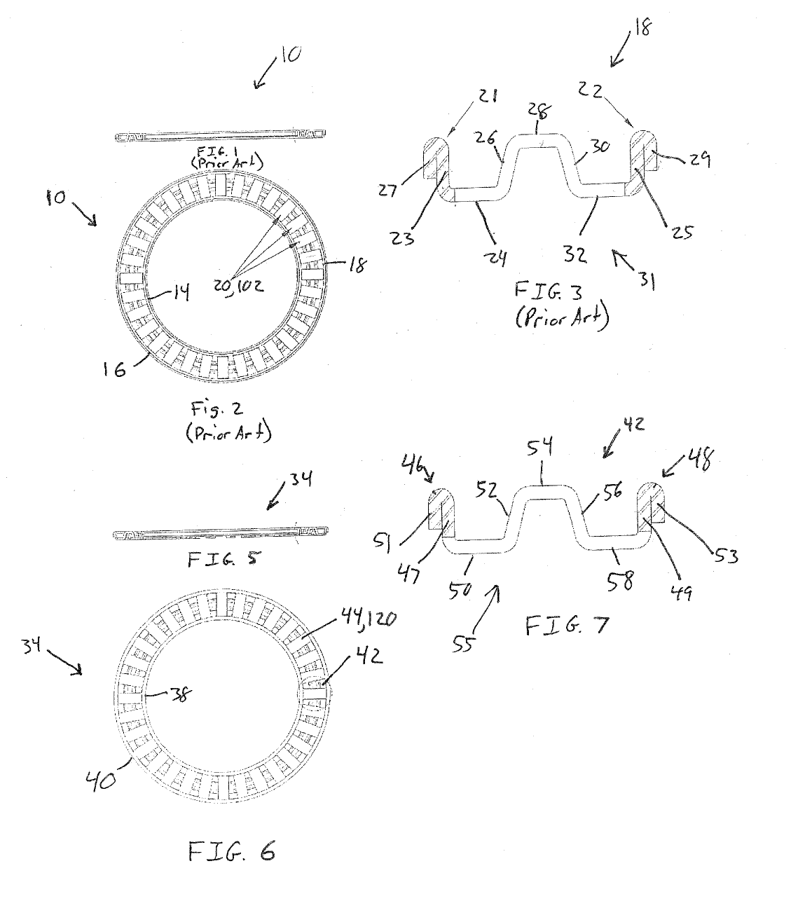

FIG. 2 shows a top view of the known axial roller bearing cage 10. The cage 10 has an inner ring 14 and an outer ring 16 and a plurality of alternating cage bars 18 and pierced roller pockets 20 located between the inner ring 14 and the outer ring 16.

FIG. 3 shows a cross-sectional view of the known roller pocket 20 formed in between the cage bars 18. On each side of the cage bars 18, the inner ring 14 and the outer ring 16 are respectively formed by the flanges 21, 22. The flanges 21, 22 each have an inboard portion 23, 25 and an outboard portion 27, 29 with the inboard portions 23, 25 defining the base 31 of the roller pocket 20. The cage bars 18 are comprised of a first segment 24, a second segment 26, a third segment 28, a forth segment 30, and a fifth segment 32. The segments 24, 26, 28, 30, 32, together with the flanges 21, 22, form the cage 10, which is sigma shaped. The cage 10 is referred to as “sigma style” cage because the cross-sectional profile of the cage bars 18 and flanges 21, 22 together resemble the capital Greek letter sigma.

FIG. 4 shows a cross-sectional view of another known roller pocket 102 formed between the cage bars 18. On each side of the cage bars 18, the inner ring 14 and the outer ring 16 are respectively formed by the flanges 104, 106. The flanges 104, 106 define the base 108 of the roller pocket 102. The cage bars 18 are comprised of a first segment 110, a second segment 112, a third segment 114, a forth segment 116, and a fifth segment 118. The segments 110, 112, 114, 116, 118, together with the flanges 104, 106, form the cage 10, which is sigma shaped.

FIG. 5 shows a side view of the axial roller bearing cage 34 of the present invention.

FIG. 6 shows a top view of the axial roller bearing cage 34 of the present invention. The cage 34 has an inner ring 38 and an outer ring 40 and a plurality of alternating cage bars 42 and roller pockets 44 located between the inner ring 38 and the outer ring 40.

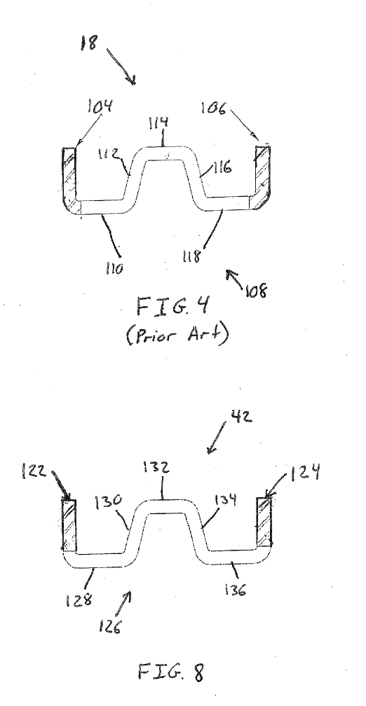

FIG. 7 shows a cross-sectional view of a roller pocket 44 formed in between the cage bars 42 of the present invention. On each side of the cage bars 42, the inner ring 38 and the outer ring 40 are respectively formed by flanges 46, 48. The flanges 46, 48 each have an inboard portion 47, 49 and an outboard portion 51, 53 with the inboard portions 47, 49 defining the base 55 of the roller pocket 44. The cage bars 42 are comprised of a first segment 50, a second segment 52, a third segment 54, a forth segment 56, and a fifth segment 58. The segments 50, 52, 54, 56, 58, together with the flanges 46, 48, form the cage 34, which is sigma shaped.

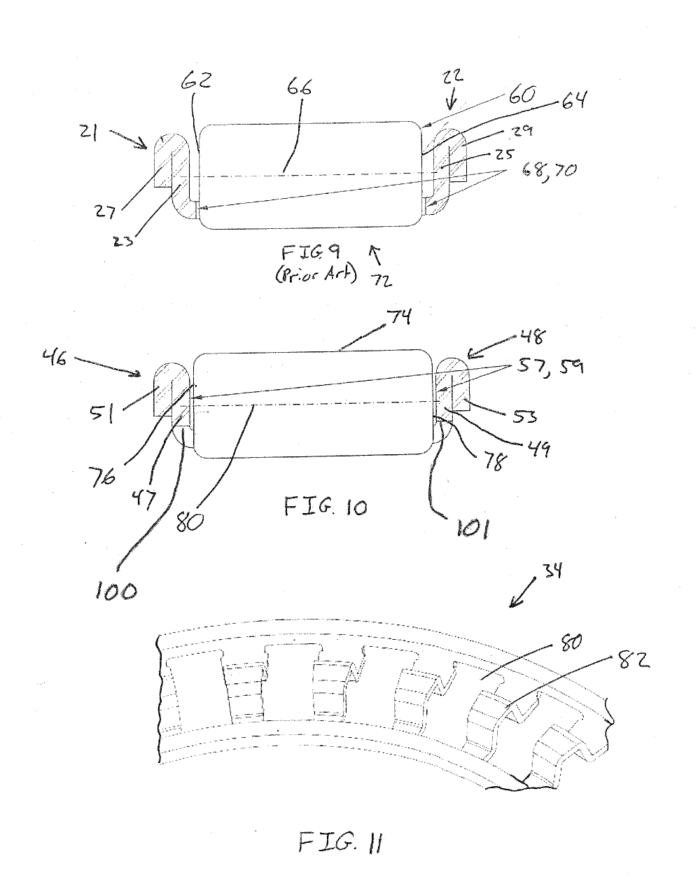

FIG. 8 shows a cross-sectional view of an alternative roller pocket 120 formed in between the cage bars 42 of the present invention. On each side of the cage bars 42, the inner ring 38 and the outer ring 40 arc respectively formed by single layer flanges 122, 124. The flanges 122, 124 define the base 126 of the roller pocket 44. The cage bars 42 are comprised of a first segment 128, a second segment 130, a third segment 132, a forth segment 134, and a fifth segment 136. The segments 128, 130, 132, 134, 136, together with the flanges 122, 124, form the cage 34, which is sigma shaped.

FIG. 9 shows a cross-sectional view illustrating the known roller pocket 20, formed between the cage bars 18, accommodating a roller 60. The ends 62, 64 of the roller 60 are supported on their periphery, along a centerline 66, by the sheared edge 68, 70 of cage stock, between the flanges 21, 22. The roller pockets 20 are currently pierced in the cage 10 by a punch (not shown) after forming. The current process limits the pocket length such that the roller pocket 20 can only accommodate rollers that are no longer than the punch length.

FIG. 10 shows a cross-sectional view illustrating the roller pocket 44 formed between the cage bars 42 of the present invention, which accommodates longer rollers 74 in the same cage envelope as the prior art cage 10. Each roller pocket 44 extends to the surfaces 57, 59 of the inboard portions 47, 49 of the flanges 46, 48, accommodating longer rollers 74. The ends 76, 78 of the rollers 74 are supported along a centerline 80, which reduces frictional torque by reducing the length of the frictional moment arm on each roller 74. Loads on the rollers 74 are symmetrical. Additionally, the ends 76, 78 are supported by the smooth surface 57, 59 of the inboard portions 47, 49 of the cage flanges 46, 48. The larger support surface improves oil film development and allows for higher operating speeds. The roller pocket 44, in which the roller 74 rests, is formed at the axial ends of the roller 74, by the inboard portions 47, 49 of the flanges 46, 48. The inboard portions 47, 49 have an end surface 100, 101 that extends from the edge of the roller pocket 44 parallel to the centerline 80 of the roller 74 and perpendicular to the ends 76, 78 of the roller 74. However, the end surface 100, 101 can also be oriented at an angle(s) that is not parallel to the centerline 80 of the roller 74 and perpendicular to the ends 76, 78 of the roller 74.

FIG. 11 shows an isometric view of a pocket configuration for the cage 34 design of the present invention.

The present invention has been described with reference to a preferred embodiment. It should be understood that the scope of the present invention is defined by the claims and is not intended to be limited to the specific embodiment disclosed herein.

What is claimed:

1. An axial roller bearing cage, comprising:
an inner ring having only a single inboard directed surface;
an outer ring having only a single inboard directed surface; and
a plurality of alternating cage bars and roller pockets formed between the inner ring and the outer ring, the roller pockets having four sides,
the single inboard directed surface of the outer ring forming a first side of the roller pocket, the single inboard directed surface of the inner ring forming a second side of the rolling pocket, opposite the first side and the second side, two opposing cage bars forming a third side and a fourth side of the rolling pocket.

2. The axial roller bearing cage of claim 1, wherein rollers sit in the roller pockets.

3. The axial roller bearing cage of claim 2, wherein the rollers have ends and the ends are each supported on a centerline of each of the rollers.

4. The axial roller bearing cage of claim 2, wherein the inner ring and the outer ring are respectively formed by a first flange and a second flange, the first flange and the second flange each having an outboard portion and an inboard portion forming a doubling.

5. The axial roller bearing cage of claim 4, wherein the first flange, the second flange and the cage bars, in combination, form a sigma shape.

6. The axial roller bearing cage of claim 5, wherein between the first flange and the second flange, each cage bar has a first segment, a second segment, a third segment, a fourth segment and a fifth segment forming the sigma shape in conjunction with the first flange and the second flange.

7. The axial roller bearing cage of claim 6, wherein the first segment is fixed perpendicular to the inboard portion of the first flange, the second segment is fixed between the first segment and the third segment in an angular manner, the third segment is fixed between the second segment and the fourth segment which is angular in an opposite direction from the second segment, the fourth segment is fixed to the third segment and the fifth segment, the fifth segment is fixed to the fourth segment and perpendicular to the inboard portion of the second flange.

8. The axial roller bearing cage of claim 4, wherein the roller pockets extend an entire length of the cage bars, to the inboard portion of the first flange and the inboard portion of the second flange.

9. The axial roller bearing cage of claim 4, wherein the ends are supported by a smooth surface provided by the inboard portion of the first flange and the inboard portion of the second flange.

10. The axial roller bearing cage of claim 4, wherein the inboard portion of the first flange and the inboard portion of the second flange have an end surface that extends from an edge of the roller pocket parallel to a centerline of the roller and perpendicular to the ends of the rollers.

11. The axial roller bearing cage of claim 2, wherein loading on the rollers is substantially symmetrical.

12. The axial roller bearing cage of claim 2, wherein the inner ring and the outer ring arc respectively formed by a single layer first flange and a single layer second flange.

13. The axial roller bearing of claim 12, wherein the single layer first flange, the single layer second flange and the cage bars, in combination, form a sigma shape.

14. The axial roller bearing cage of claim 12, wherein between the single layer first flange and the single layer second flange, each cage bar has a first segment, a second segment, a third segment, a fourth segment and a fifth segment forming the sigma shape in conjunction with the single first flange and the single second flange.

15. The axial roller bearing cage of claim 12, wherein the first segment is fixed perpendicular to an inboard face of the single layer first flange, the second segment is fixed between the first segment and the third segment in an angular manner, the third segment is fixed between the second segment and the fourth segment which is angular in an opposite direction from the second segment, the fourth segment is fixed to the third segment and the fifth segment, the fifth segment is fixed to the fourth segment and perpendicular to an inboard face of the single layer second flange.

16. The axial roller bearing cage of claim 12, wherein the roller pockets extend an entire length of the cage bars, to an inner surface of the single layer first flange and an inner surface of the single layer second flange.

17. The axial roller bearing cage of claim 12, wherein the ends are supported by a smooth surface provided by an inner surface of the single layer first flange and an inner surface of the single layer second flange.

18. The axial roller bearing cage of claim 12, wherein an inner surface of the single layer first flange and an inner surface of the single layer second flange have an end surface that extends from an edge of the roller pocket parallel to a centerline of the roller and perpendicular to the ends of the rollers.

19. The axial bearing cage of claim 1, wherein the inner ring is formed from a first flange having an outboard portion and an inboard portion and the outer ring is formed from a second flange having a single layer portion.

20. The axial bearing cage of claim 1, wherein the inner ring is formed from a first flange having a single layer portion and the outer ring is formed from a second flange having an outboard portion and an inboard portion.
